(19) United States
(12) Patent Application Publication
(10) Pub. No.: US 2024/0327716 A1
(43) Pub. Date: Oct. 3, 2024

(54) Hydrotreatment of Vegetable Biomass

(71) Applicant: B.T.G. Advanced Biofuel Company B.V., Enschede (NL)

(72) Inventor: Robertus Hendrikus Venderbosch, Enschede (NL)

(21) Appl. No.: 18/576,180

(22) PCT Filed: Jul. 8, 2021
(86) PCT No.: PCT/EP2021/069028

§ 371 Date: Jan. 3, 2024

(51) Int. Cl. C10G 1/06; C10G 1/02

(52) U.S. Cl. CPC C10G 1/06; C10G 1/02; C10G 2300/1014

(57) ABSTRACT

Provided herein are a method and means for the hydrotreatment of vegetable biomass and especially the hydrotreatment of pyrolysis oil. The present methods and means are especially useful in processes for the production of biofuels and/or renewable chemical compounds or intermediates. Specifically, the present invention relates to method for hydrotreatment of vegetable biomass, the methods include the step of: a) subjecting a mixture of concentrated hydrotreated vegetable biomass with a water content of less than 50 wt. % and a non-hydrotreated vegetable biomass to a hydrotreatment in the presence of a catalyst and hydrogen at an elevated pressure of 1000 kPa to 35000 kPa (10 bar to 350 bar) and an elevated temperature of 50° C. to 450° C.

### CROSS-REFERENCE TO RELATED APPLICATION

This application is the United States national phase of International Application No. PCT/EP2021/069028 filed Jul. 8, 2021, the disclosure of which is hereby incorporated by reference in its entirety.

### BACKGROUND OF THE INVENTION

### Field of the Invention

The present invention relates to method and means for the hydrotreatment vegetable biomass and especially the hydrotreatment of pyrolysis oil. The present methods and means are especially useful in processes for the production of biofuels and/or renewable chemical production or intermediates therefor.

### Description of Related Art

Being the only sustainable or renewable product containing carbon, vegetal biomasses are the only alternative for fossil derived crude oil derivatives. Research on the use of biomass, particularly from vegetal sources, for first generation biofuels is rapidly expanding such as bioethanol from sugar sources and starches and bio-diesel from pure plant oils. Biomass, in particular biomass comprising of ligno-cellulosic materials, is difficult to convert into biofuels.

Conventional refinery scales, generally up to 100 ton/hour crude oil equivalence, are preferable for economic reason, but problematic for biomass resources usually scattered and requiring expensive and difficult collection. In addition, various types of biomass are different in structure and composition and. accordingly the handling procedures have continuously to be adapted, have a low energy density compared to many fossil resources, and often contain significant amounts of water and ash.

These disadvantages can be overcome if the biomass is firstly decentrally restructured, densified at a smaller scale such as 2 to 10 ton/hour while the intermediate product can be transported to a large central processing unit where it is transformed to a more stable product such as at a scale of 50 to 200 ton/hour.

A potentially attractive technology for this purpose is fast pyrolysis. In this process organic materials are heated to 450 to 600° C. with a short temperature/time ramp, in absence of air. The meaning of a short temperature/time ramp depends on the type of material to be fast pyrolysed. Under fast pyrolysis conditions, organic vapours, permanent gases and charcoal are produced.

The vapors are condensed to a rather clean and uniform liquid, also referred to as “untreated pyrolysis liquid” or “PL”. These liquids contain negligible amounts of ash and have a volumetric energetic density 5 to 20 times higher than the original biomass. The liquids generally contain water in amounts of 15 to 30 wt. %, and are highly polar. On water-free basis, defined as the material composition if the amount of water is adjusted for, the oxygen content ranges from 35 to 50 wt. % (weight basis). Typically, 50 to 75 wt. % of the feedstock can be converted into liquid. The untreated pyrolysis liquids can be used in the production of renewable/sustainable energy and chemicals.

However, pyrolysis oils are rather chemically unstable. An indicator to assess the degree of stability is its tendency to produce coke, for example via the residue retained upon distillation. Examples are the Conradson Carbon Residue or the Micron Carbon Residue (abbreviated CCR and MCR, respectively).

CCR and MCR both can be measured via a Standard Test Method for Conradson Carbon Residue (for example from the American National Standard Institute). Carbon residue values are determined via a standard industrial coking test for characterizing coke forming tendency. A similar analysis can be carried out using thermogravimetric analysis or thermal gravimetric analysis (TGA), in which a sample of material is heated up to a temperature of 900° C. under nitrogen in the absence of air while the weight of the remaining sample is continuously measured. The weight of the residue remaining is referred to as TGA residue. In general, pyrolysis-oils have CCR values around 10 to 30 wt. % while CCR-values for feeds for refinery applications, such as Fluid Catalytic Cracking (FCC), are generally <5 wt. %.

Another drawback is that untreated pyrolysis liquids are immiscible with conventional crude oil derivatives and cannot readily be processed in refinery units. However, they can be treated to allow (some) miscibility with fossil fuels. Several processes for treating the pyrolysis liquids have been proposed. Relevant examples include the use of catalysts in hydrogenation of bioliquids under hydrogen pressures, using catalysts during pyrolysis, or feeding the pyrolysis vapors as such over catalysts. These upgrading processes for the pyrolysis oil may involve, for instance, removal of the oxygen (typically >95%), decarboxylation, viscosity reduction, sulphur removal, nitrogen removal, and the like.

Processes are known aimed at hydrogenation or hydrodeoxygenation of vegetable biomass feed typically generated from fast pyrolysis, in which a simultaneous hydrogenation, deoxygenation and cracking takes place. These processes require high pressures of hydrogen, for instance, in the range of 50 bar to 350 bar and temperatures ranging from 50 up to 450° C., to remove (part of) the oxygen from the pyrolysis oil in the form of water, CO or CO₂ (CO_{X}) and light hydrocarbons (CₓH_{y}).

A distinction is made between using untreated pyrolysis liquid (PL), and treated pyrolysis liquids as the untreated vegetable biomass feed. Treated pyrolysis liquids, also referred to as SPO, are untreated pyrolysis liquid hydrotreated over dedicated catalysts. These liquids already have a certain degree of improvement compared to the untreated pyrolysis liquids, and for which certain characteristics have already been improved through hydroprocessing and/or any further treatment such as an contaminant removal (such as water).

Hydrotreatment processes usually imply high hydrogen consumption, which makes them uneconomical and difficult to carry out. One disadvantage is that a significant exothermic methanation occurs of any COₓ produced in the process, leading to high hydrogen consumption delivering less valuable gaseous hydrocarbons. These non-preferential side reactions are promoted at high pressures (100 to 200 bar) and elevated temperatures (typically between 25° and 450° C.), while high pressures are required to account for a limited solubility of the hydrogen in polar components such as water, and consequently in vegetable biomass derived liquids.

Temperatures in the hydrotreatment are important to control, because high temperatures result in increased yields of gaseous COₓ promoting with hydrogen methanation. This causes disadvantageous effects, such as increased hydrogen consumption and increased temperatures and the possibility of out of control processes.

Thus, while high pressures are necessary due to a limited solubility of the hydrogen, there is a strong need to be able to control reaction temperature excursions that are promoted by this same pressure. For example, at pressures of 200 bar, only at temperatures exceeding 450° C. methanation reactions are, to some extent, suppressed by the equilibrium.

One industrial option is to recycle a (usually large) excess of cold hydrogen, cooling the reactions but also allowing an optimal degree of conversion, and thus reaction heat, per reaction segment. As a main disadvantage, however, the specific heat content of hydrogen is very limited, and its density very low, which requires the addition of very large recycle stream of hydrogen if such deoxygenation reactions are considered.

This is not the most economical option, especially because the hydrogen, required in large excess as it has a relatively low heat capacity, is recycled from the outlet, and in almost all cases contaminated with other components, such as COₓ and CₓH_{y}. These gases require cleaning and repressurisation before allowing to recycling it back to the reactors.

Another option is to feed cold hydrogen at specific positions in the reactor to cool the dedicated reactor part, but additionally to reduce the hydrogen excess to control the methanation by a shortage in hydrogen. The latter options, however, is less or not preferred for pyrolysis liquids, because shortage in hydrogen will promote polymerization reactions over the preferred hydrogenation reactions, leading to plugging of reactor parts.

In view of the above, there is a need in the art for an improved process for hydrotreating vegetable biomass and especially pyrolysis liquids. It is an object of the present invention, amongst other objects, to address this need in the art.

### SUMMARY OF THE INVENTION

According to the present invention, this object, amongst other objects, is met as outlined in the appended claims.

Specifically, according to a first aspect, this object, according to other objects, is met by method for hydrotreatment of vegetable biomass, the methods comprise the step of:
a) subjecting a mixture of concentrated hydrotreated vegetable biomass with a water content of less than 50 wt. % and a non-hydrotreated vegetable biomass to a hydrotreatment in the presence of a catalyst and hydrogen at an elevated pressure of 1000 kPa to 35000 kPa (10 bar to 350 bar) and an elevated temperature of 50° C. to 450° C.

The present inventors have surprisingly found that the present method addresses the need for reducing the pressure inside reactors without negatively affecting the process performance or even improve the performance.

The present methods provide an improved process for the treatment of biomasses from vegetal sources which are technically easier to carry out, and more effective. Further, the present methods can be completed in a short amount of time and/or that can be carried out at milder conditions compared to known methods. Furthermore, the present methods provide reaction products with improved suitability for downstream processing. Also, the present method provide improved stability of biomass derived liquids, yielding a product comprising a low water content, a low coking tendency, low viscosity and/or lower amounts of acids. Additionally, high overall carbon yield from biomass to final products is obtained with the methods according to the present invention.

According to a preferred embodiment, the present methods further comprise the steps of:
b) separating the hydrogenated mixture of step (a) into a gas phase and a liquid phase and partially concentrating the separated liquid phase to form a liquid with a water content of less than 50 wt %, the remainder of the liquid phase being used for downstream processing of hydrogenated vegetable biomass;
c) mixing the concentrated liquid phase with non-hydrotreated vegetable biomass;
d) subjecting the mixture of step (c) to a hydrotreament in the presence of a catalyst and hydrogen at an elevated pressure of 1000 kPa to 35000 kPa (10 bar to 350 bar) and an elevated temperature of 50° C. to 450° C.
e) optionally repeating steps (b) to (d).

As main advantages of this approach recycling (part of) the treated material, allows a direct, rapid and much better controlled temperature in the reactors while already reacted materials are added and the inert feed will dampen any temperature increase. However, and surprisingly, recycling of treated materials provides other beneficial effects;
A low solubility of hydrogen in polar materials, such as pyrolysis liquids, is to be compensated for by a high pressure of typically 150 to 200 bar, mainly in the treatment of such untreated pyrolysis liquids. Beneficially though, due to the addition of less polar, treated materials, the apparent characteristics of the mixtures allow higher solubility of the hydrogen, and lower pressures are possible, while feed and treated products are (partially) miscible. For the pyrolysis liquid to SPO a preferred pressure is below 100 bar and for the treated pyrolysis liquids <50 bar, in comparison with non-recycling treatment 150 to 200 bar, and 80 to 200 bar resp.
Due to the recycling, the active component concentration decreases, and reduces the effects of typical second-order repolymerisation reactions. This, at the same time reduces the extent of the CO₂ formation, and together with the lower pressures further limits the effects of the very exothermic methanation of CO₂ to methane.
Similarly, due to the lower concentration of reactive components, including the apparent water and acid content, a lower deactivation of catalyst is seen, at the same time causing less leaching of active catalyst materials also because of much better controlled reactor temperature ranges.

According to the present invention, untreated vegetal biomass can be contacted with a catalyst suitable for the hydrotreatment carried out, i.e. a treatment with hydrogen. Vegetal biomass can be contacted with at least one catalyst and is hydrotreated until a predetermined level of hydrotreatment of biomass is obtained.

The catalyst can be one catalyst or the combination catalysts, such as two catalysts or more, three catalysts or more, four catalysts or more, five catalysts or more. The catalyst can comprise more than one metal, also designated by a mixed metal catalyst. A catalyst is a reagent that participates in the chemical reaction but is not consumed by the reaction itself. The catalyst used in the present methods can be any known catalyst, such as a catalyst comprising copper, or copper, zinc oxide, or copper zinc oxide and alumina or a catalyst comprising chrome oxide and zinc oxide. The catalyst can advantageously be chosen from a metallic oxide, a metallic hydride, or a metallic oxysalt comprising at least one of the metals chosen from the group Al, Cu, Cr, Cs, Fe, Ir, La, Mo, Mn, Ni, Pd, Rh, Si, Sm, Ti, Zn.

The predetermined level of hydrotreatment is a desired level of hydrogen that is consumed in the conversion of the specific feedstock, defined in m³ of hydrogen (normal conditions, or Nm³) per kg untreated vegetable biomass. The predetermined level of hydrogen consumption defines the completion of the conversion of hydrogen and the vegetal biomass. Suitable levels are at least 0.10, at least 0.16, at least 0.22, at least 0.28, at least 0.34 or 0.40 (all Nm³ per kg untreated vegetable biomass). Accordingly, the process according to the present invention comprises performing the reaction until the predetermined level of conversion is reached.

According to the present invention untreated vegetable biomass can be pyrolysis liquids, yielding a treated vegetable biomass, referred to as SPO, or a prior treated pyrolysis derived liquid to yield a further treated vegetable biomass, referred to as SDPO. Typically, the mildly treated SPO contains 20 to 40 wt. % oxygen (water-free basis), and the more severely treated SDPO below 15 wt. % (water-free basis).

For untreated pyrolysis liquid as feed, the conversion in the SPO is defined mainly by the increase of the ratio between hydrogen and carbon (H/C)—calculated on water-free basis—in the product molecules. Typical temperatures to yield SPO from untreated pyrolysis liquids are in between 120° C. and 250° C., deploying catalysts that promote hydrogenation. For the treated pyrolysis liquid ‘SPO’ as feed the conversion in the SDPO is defined mainly by the decrease of the ratio between oxygen or carbon (O/C)—calculated on water-free basis—in the product molecules. Typical temperatures to yield SDPO from untreated pyrolysis liquids or from SPO are in between 250° C. and 450° C., deploying catalysts that promote deoxygenation.

According to the present invention, the treated vegetal biomass obtained is separated into two fractions, an aqueous fraction and an organic fraction. By “fraction” is to be understood a part of the vegetal biomass. “Fraction” can also be designated as a phase. An aqueous fraction is to be understood as a fraction comprising water. An organic fraction can be understood as a fraction made of hydrocarbons. The hydrocarbons may also contain oxygen, or functional groups comprising one or more oxygen.

Particularly, the treated vegetal biomass obtained comprises a mixture of water and of alcoholic components and an organic fraction, where its composition varies according to the origin of the biomass and the process parameters. The treated vegetable biomass can be concentrated to obtain a concentrate of organics and alcohols as well as a phase comprising mainly water (‘process water’). The process water can be further treated elsewhere.

Concentrating the product can be out by one or more steps selected from distillation, condensation, phase separation, sedimentation, filtration and chromatography. The concentrating (or dewatering) can also be carried out by more than one successive step selected from distillation, condensation, phase separation, sedimentation, filtration and chromatography.

According to the present invention, the concentrate is mixed with untreated vegetable biomass to carry out a further hydrotreatment. The ratio concentrated hydrotreated vegetable biomass to non-hydrotreated vegetable biomass in the mixtures of step (a) and/or step (c) can be 0.2 to less than 20, preferably 0.2 to less than 10, more preferably 0.2 to less than 5, most preferably 0.2 to less than 2.

The final products, SPO or SDPO obtained can be used in different applications, such as in combustion, in gasification, via conventional distillation for chemical, but also in any further processing to arrive at products similar to fossil fuels, i.e. downstream processing of hydrogenated vegetable biomass comprises production of biofuel and/or production of alternatives for fossil oil derivatives and/or production of intermediates to further produce alternatives for fossil fuel derivatives, or for the production of chemicals.

Taking untreated pyrolysis liquid as the untreated vegetable biomass the final product is a stabilized pyrolysis oil (“SPO”), because it presents the advantage that it is stabilized and that the overall carbon yield is increased significantly. SPO is reportedly distillable, with no significant coke formation, and co-processing in a laboratory FCC facility (designated as ‘Micro Activity Testing’ or MAT) is demonstrated.

Taking a treated pyrolysis liquid SPO as the untreated vegetable biomass the final product is a stabilized deoxygenated pyrolysis oil (“SDPO”), because it presents the advantage that it is stabilized as well as partially deoxygenated.

The present methods preferably use as elevated pressure in step (a) and/or step (d) 1000 kPa to 25000 kPa (10 bar to 250 bar), preferably 1000 kPa to 15000 kPa (10 bar to 150 bar), more preferably 1000 kPa to 5000 kPa (10 bar to 50 bar).

According to the present invention, the concentrated hydrotreated vegetable biomass can be concentrated hydrotreated pyrolysis oil, preferably concentrated hydrotreated fast pyrolysis oil and the non-hydrotreated vegetable biomass can be non-hydrotreated pyrolysis oil, preferably non-hydrotreated fast pyrolysis oil.

According to an especially preferred embodiment, the concentrated hydrotreated vegetable biomass has a water content of less than 12.5 wt %, preferably less than 10 wt %, more preferably less than 9 wt %, most preferably less than 8 wt %.

According to yet another especially preferred embodiment the vegetable biomass comprises lignitic, hemi-cellulosic and/or cellulosic material.

Considering the advantages of the present method, the invention relates according to a second aspect to installation suitable for performing the present methods, the installations comprises:
a reactor (1) for catalytic hydrogenation, the reactor (1) comprises an inlet (10) for a hydrogen feed (100) and an inlet (20) for a feed (200) of mixture of concentrated hydrotreated vegetable biomass with a water content of less than 50 wt % and non-hydrotreated vegetable biomass; and an outlet (30) feeding a hydrogenated mixture (300) to;
a separator (2) for separating the hydrogenated mixture (300) into a gas phase (400) and a liquid phase (500), the separator is provided with an outlet (40) for feeding, at least partially, the liquid phase (500) to;
a concentrator (3) for concentrating the liquid phase (500) until a water content of less than 50 wt %, the concentrator (3) is provided with an outlet (50) for feeding the concentrated liquid phase (600) to;
a mixer (4) for mixing the feed of concentrated liquid (600) with a feed of non-hydrogenated vegetable biomass (700), the mixer (4) is provided with an outlet (60) for providing inlet (20) of reactor (1) with a feed (200) of mixture of concentrated hydrotreated vegetable biomass with a water content of less than 50 wt % and non-hydrotreated vegetable biomass.

According to a preferred embodiment, separator (2) further comprises an outlet (70) for recycling, optionally after purification, the gas phase into hydrogen feed (100).

According to an especially preferred embodiment, the present installations further comprise a pyrolysis assembly for providing non-hydrotreated pyrolysis oil, preferably non-hydrotreated fast pyrolysis oil.

### BRIEF DESCRIPTION OF THE DRAWINGS

The present invention will be further detailed in the following examples. In the examples, reference is made to figures wherein:

FIG. 1: shows a flowsheet for the deoxygenation of stabilized pyrolysis oil by hydrotreating;

FIG. 2: shows the temperature recording from the thermowells located in the first reactor (TI-403 to TI-405). In addition, the temperature used to monitor the temperature of the first reactor, TI-402 is shown as well, all temperatures versus the running time;

FIG. 3: shows the temperature recording from the thermowells from the third reactor (TI-423 to TI-425). In addition, the temperature used to control the temperature of the third reactor TI-422 is shown as well. All temperatures are plotted versus the running time;

FIG. 4: shows the temperature recording from the thermowells now from the first reactor (TI-403 to TI-405). In addition, the temperature used to control the temperature of the reactor TI-402 is shown as well. All temperatures are plotted versus the running time.

### DESCRIPTION OF THE INVENTION

### Example 1

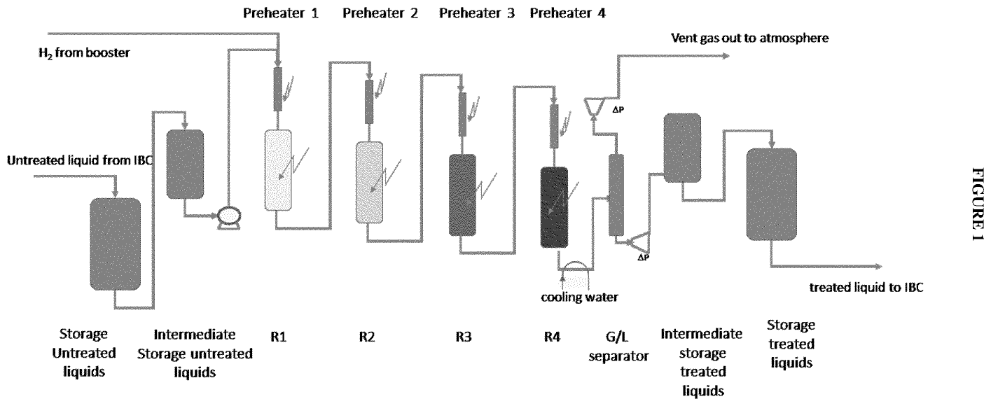

A typical process for hydrotreating pyrolysis liquids is shown in FIG. 1. Feedstock is pumped from a feeding vessel to the preheater and subsequent a first reactor section R1 where after it is fed over a second preheater 2, reactor R2, third preheater 3, reactor R3, and finally a fourth preheater 4 and reactor R4. Each reactor segment thus comprises of an oil-gas preheater (Preheater 1 to Preheater 4) and a Catalyst Bed Reactor (R1 to R4). The reactors are placed in sequence, and oil/hydrogen flows from the first reactor are fed to the second, to the third and the fourth segment, allowing some increase in the temperatures in each subsequent reactor segment.

The preheaters are individually heated to the required temperature by spiraled electrical heaters placed around the tube. The temperature of the preheater is measured by a thermocouple and controlled via a separate thermocouple through temperature controller units. From the preheater, the liquid/gas is introduced in a reactor (each ˜1 L volume; L=0.51 m, ID=40.3 mm) filled with dedicated catalyst (approx. 1.0 kg each). Each reactor is individually heated. At two positions outside the reactor thermocouples are placed to control and safeguard the temperature resp. Each reactor is operated in down-flow, while the lining in between the reactors is in up-flow, as to reduce the height of the complete installation. Heating of each reactor is done individually by using electric heaters and measured/controlled by so-called thermo-well introduced to measure and control local temperatures in the catalyst bed and over the whole reactor length. Each thermowell has three thermocouples, here referred to as TI-403, TI-404, and TI-405 for the first reactor (from top of the reactor to the bottom), TI-413, TI-414 and TI-415 for the second reactor, TI-423, TI-424 and TI-425 for the third reactor and TI-433, TI-434, and TI-435 for the fourth reactor. Shutdown of the system is activated if temperature rise above a threshold value.

Hydrogen is taken from a series of hydrogen bottles. Its pressure is first reduced to a threshold value typical 45 bar, before it is fed to the booster system. The maximum pressure in the gas booster buffer vessel is typically around 230 bar, approx. 30 bar above the maximum applied reactor pressure. From the booster the pressure is reduced down to a pressure 10 to 20 bars above the desired operating pressure. The flow of hydrogen is controlled using mass flow controllers.

The reactor gas-liquid exit stream is cooled to room temperature by heat exchanging in a water-cooler, and the cooled mixture is led into a G/L separator operated at the high pressure. Two level switches, and a level sensor are attached at the outside of the chamber to monitor and control the liquid level respectively.

The gas leaves the separator at the top and is depressurized to atmospheric pressure by techniques well known to those experienced in the art. The gas is directed into an intermediate vessel, and subsequently further cooled by a cooler to a minimum of −20° C., regulated by a cooling bath to condense all possibly formed liquids. A gas flow meter records the flow of gas.

Similarly, the liquid is depressurized to atmospheric pressure by techniques well known to those experienced in the art. The liquid product flows into a product collection vessel, its weight monitored constantly by a weighing scale.

### Example 2

In a typical example, untreated vegetable biomass obtained from pyrolysis are treated over conventional sulphided NiMo catalysts, at 200 bar hydrogen pressure to produce an oil with limited oxygen content (here referred to as Stabilized Deoxygenated Pyrolysis Oil, or SDPO), typically below 15 wt. % (water-free basis). Here the feedstock is a material that has undergone a partial hydrotreatment in an earlier process, resulting in a material—a so-called stabilized pyrolysis oil or SPO—that already has less oxygen content that pure pyrolysis liquids, typically below 40 wt. % on water-free basis. As a main difference compared to pure pyrolysis liquids, the overall hydrogen content is higher, resulting in a better oil quality, especially in terms of coking tendency, here referred to as MCR or the MicroCarbon Residue. This value represents the fraction that is not distillable upon heating at 500° C. The main characteristics of the feed are listed below in Table 1. Typical operating conditions are listed in Table 2.

TABLE 1

| | | | Product |
|---|---|---|---|
| | | | (SDPO) |
| Elemental | Feed | Elemental | (internal |
| composition wt. % | (SPO) | composition wt. % | ref 1666) |
| Carbon | 67.0-71.2 | Carbon | 80-84 |
| Hydrogen | 8.8-9.5 | Hydrogen | 10-11 |
| Oxygen | 19.5-24 | Oxygen | 5-8 |
| Nitrogen | 0.27-0.28 | Nitrogen | 0.1 |
| MCR wt. % | 4.4-5.7 | MCR wt. % | <0.1 |
| Water wt. % | 4.4-8.2 | Water wt. % | <0.5 |

TABLE 2

| Feed type | SPO | |
|---|---|---|
| Liquid flow | 1 | L/h |
| Control temperature Reactor 1 | 310° | C. |
| Control temperature Reactor 2 | 325° | C. |
| Control temperature Reactor 3 | 340° | C. |
| Control temperature Reactor 4 | 355° | C. |
| Hydrogen flow | 9 | NL/min |
| Pressure | 200 | bar |

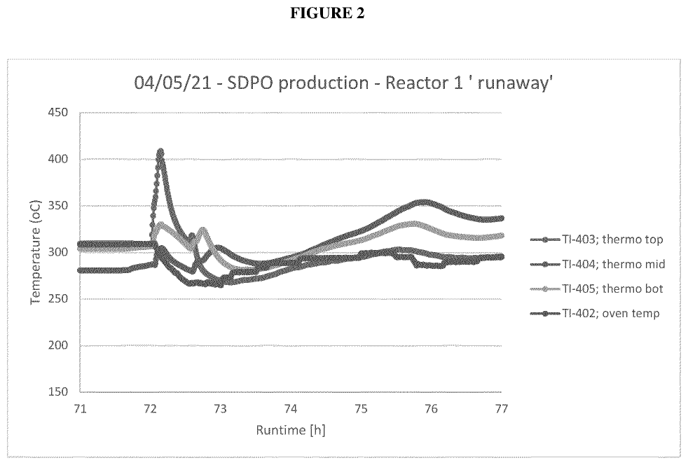

FIG. 2 shows the temperature recording from the thermowells located in the first reactor (TI-403 to TI-405). In addition, the temperature used to monitor the temperature of the first reactor, TI-402 is shown as well, all temperatures versus the running time. Feeding was started just 10 minutes before a temperature increase was noted, and the reactor temperature control was manually decreased to stop heating the reactor further. This operation failed, while the reactor control was reduced quickly from 300° C. down to 260° C., a sharp increase of the temperature inside the reactor bed was noted. This is in particular noted through the top thermocouple TI-403, that was stable at 300° C. as well, but suddenly rises above 400° C. at which point an emergency shutdown is activated. After one hour, and a decrease in temperature inside the bed is noted, operation is resumed.

### Example 3

In a third example the similar untreated vegetable biomass from pyrolysis (see Table 1) are treated over conventional sulphided NiMo catalysts, at 200 bar hydrogen pressure, in a standard approach to deoxygenate the material further. Similar product compositions of the so-called DSPO were obtained as in Example 2. Here the feedstock is a material that has undergone a partial hydrotreatment and deoxygenation in an earlier process. Typical operating conditions are listed in Table 3.

TABLE 3

| Feed type | SPO | |
|---|---|---|
| Liquid flow | 1 | L/h |
| Control temperature Reactor 1 | 305° | C. |
| Control temperature Reactor 2 | 345° | C. |
| Control temperature Reactor 3 | 365° | C. |
| Control temperature Reactor 4 | 380° | C. |
| Hydrogen flow | 9 | NL/min |
| Pressure | 200 | bar |

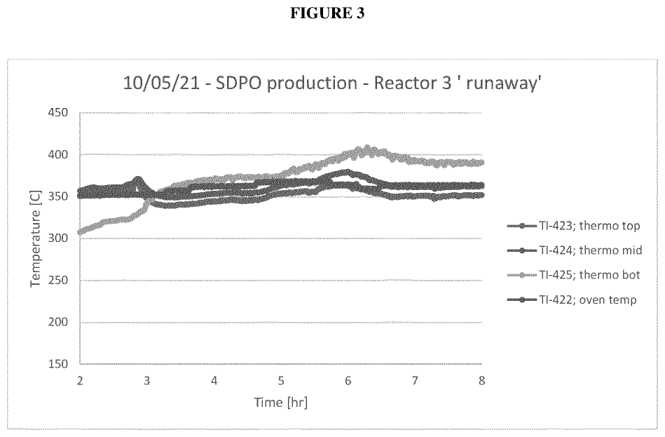

FIG. 3 shows the temperature recording from the thermowells now from the third reactor (TI-423 to TI-425). In addition, the temperature used to control the temperature of the third reactor TI-422 is shown as well. All temperatures are plotted versus the running time. After introduction of the untreated feed the temperatures appear rather stable, however on 5 hr in the experiment a limited temperature increase in the temperature control was set, approx. +5° C. and only a minor drop in the reactor measurement temperature TI-422 is noted, from 367° C. down to 360° C. However, this led to a significant increase in the temperature inside the reactor bed. This was in particular noted through the top thermocouple TI-423, that was rather constant at 377° C., but rises above 400° C. after the 5° C. increase in setpoint. A manual action of the operator was necessary again, lowering the set temperatures of the system and only after one hour a sufficient decrease in temperature inside the bed is noted to allow further ‘normal’ operation.

### Example 4

In this fourth example a mixture of treated and untreated liquids from pyrolysis (50%:50% by weight) are treated over conventional sulphided NiMo catalysts (see Table 4), now at 100 bar hydrogen pressure, in a standard approach to deoxygenate the material further. Here the feedstock is a material that has undergone a partial hydrotreatment and deoxygenation in an earlier process. The characteristics of the feed and product are listed below in Table 4. Typical operating conditions are listed in Table 5. Unexpectedly, although Reactor 4 was set at 400° C. no severe temperature excursions were noted in this reactor as well. Similar product compositions were obtained from this runs as listed in Example 2.

TABLE 4

| Elemental | Feed | Elemental | Feed | Elemental | |
|---|---|---|---|---|---|
| composition | SDPO | composition | SPO | composition | Mix |
| wt. % | 1668 | wt. % | 0383 | wt. % | 1760 |
| Carbon | 83.6 | Carbon | 54.3 | Carbon | 69 |
| Hydrogen | 10.7 | Hydrogen | 7.74 | Hydrogen | 9.2 |
| Oxygen | 5.5 | Oxygen | 37.9 | Oxygen | 21.7 |
| Nitrogen | 0.08 | Nitrogen | 0.07 | Nitrogen | 0.07 |
| MCR wt. % | 0.1 | MCR wt. % | 8.9 | MCR wt. % | 4.5 |
| Water wt. % | 1.7 | Water wt. % | 9.1 | Water wt. % | 5.4 |

| | Product (SDPO) |
|---|---|
| Elemental composition wt. % | (internal ref 1776) |
| Carbon | >86 |
| Hydrogen | >11 |
| Oxygen | ≈2 |
| Nitrogen | 0.2 |
| MCR wt. % | <0.1 |
| Water wt. % | <0.5 |

TABLE 5

| Feed type | 50% SPO + 50SDPO | |
|---|---|---|
| Liquid flow | 1 | L/h |
| Control temperature Reactor 1 | 300° | C. |
| Control temperature Reactor 2 | 335° | C. |
| Control temperature Reactor 3 | 365° | C. |
| Control temperature Reactor 4 | 400° | C. |
| Hydrogen flow | 9 | NL/min |
| Pressure | 100 | bar |

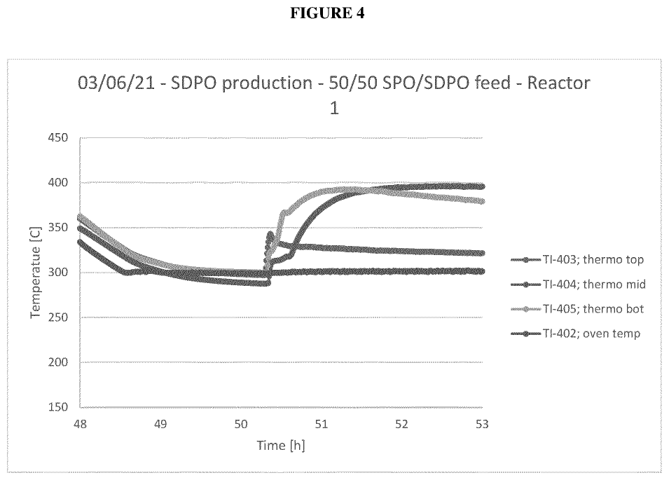

FIG. 4 shows the temperature recording from the thermowells now from the first reactor (TI-403 to TI-405). In addition, the temperature used to control the temperature of the reactor TI-402 is shown as well. All temperatures are plotted versus the running time. Surprisingly, after introduction of the feed the temperatures appear very stable, and no drop at all in the reactor controlling temperature TI-402 is noted and no intervention from the operators were necessary. All reactor control temperatures remained constant at 300° C. None of the thermocouples in the thermowell (TI-402-TI-403) appear temperature excursions above 400° C., and no shutdown was activated. All temperatures could be well controlled to stay below this emergency shutdown value, with an additional freedom to operate being the ratio between the treated and untreated liquids fed to the first reactor.

1. A method for hydrotreatment of vegetable biomass, the method comprises the step of:
a) subjecting a mixture of concentrated hydrotreated vegetable biomass with a water content of less than 50 wt. % and a non-hydrotreated vegetable biomass to a hydrotreatment in the presence of a catalyst and hydrogen at an elevated pressure of 1000 kPa to 35000 kPa (10 bar to 350 bar) and an elevated temperature of 50° C. to 450° C.

2. The method according to claim 1, further comprising the steps of:
b) separating the hydrogenated mixture of step (a) into a gas phase and a liquid phase and partially concentrating the separated liquid phase to form a liquid with a water content of less than 50 wt. %, the remainder of the liquid phase being used for downstream processing of hydrogenated vegetable biomass;
c) mixing the concentrated liquid phase with non-hydrotreated vegetable biomass;
d) subjecting the mixture of step (c) to a hydrotreament in the presence of a catalyst and hydrogen at an elevated pressure of 1000 kPa to 35000 kPa (10 bar to 350 bar) and an elevated temperature of 50° C. to 450° C.
e) optionally repeating steps (b) to (d).

3. The method according to claim 1, wherein downstream processing of hydrogenated vegetable biomass comprises production of biofuel and/or production of alternatives for fossil oil derivatives and/or production of intermediates to further produce alternatives for fossil fuel derivatives, or for the production of chemicals.

4. The method according to claim 1, wherein a ratio of concentrated hydrotreated vegetable biomass to non-hydrotreated vegetable biomass in the mixtures of step (a) and/or step (c) is 0.2 to less than 20.

5. The method according to claim 1, wherein the elevated pressure in step (a) and/or step (d) is 1000 kPa to 25000 kPa (10 bar to 250 bar).

6. The method according to claim 1, wherein the concentrated hydrotreated vegetable biomass is concentrated hydrotreated pyrolysis oil.

7. The method according to claim 1, wherein the non-hydrotreated vegetable biomass is non-hydrotreated pyrolysis oil.

8. The method according to claim 1, wherein the concentrated hydrotreated vegetable biomass has a water content of less than 12.5 wt %.

9. The method according to claim 1, wherein the vegetable biomass comprises lignitic, hemi-cellulosic, and/or cellulosic material.

10. The method according to claim 2, wherein concentrating in step (b) is selected from one or more of the group consisting of distillation, condensation, separation, sedimentation, filtration, and chromatography.

11. An installation for performing a method according to claim 1, the installation comprising:
a reactor for catalytic hydrogenation, the reactor comprising an inlet for a hydrogen feed an inlet for a feed of mixture of concentrated hydrotreated vegetable biomass with a water content of less than 50 wt % and non-hydrotreated vegetable biomass; and an outlet feeding a hydrogenated mixture to;
a separator for separating the hydrogenated mixture into a gas phase and a liquid phase, the separator is provided with an outlet for feeding, at least partially, the liquid phase;
a concentrator for concentrating the liquid phase until a water content of less than 50 wt %, the concentrator is provided with an outlet for feeding the concentrated liquid phase;
a mixer for mixing the feed of concentrated liquid with a feed of non-hydrogenated vegetable biomass, the mixer is provided with an outlet for providing inlet of reactor with a feed of mixture of concentrated hydrotreated vegetable biomass with a water content of less than 50 wt % and non-hydrotreated vegetable biomass.

12. The installation according to claim 11, wherein separator further comprises an outlet for recycling, optionally after purification, the gas phase into hydrogen feed.

13. The installation according to claim 11, further comprising a pyrolysis assembly for providing non-hydrotreated pyrolysis oil.
